(19) United States
(12) Patent Application Publication
(10) Pub. No.: US 2012/0026891 A1
(43) Pub. Date: Feb. 2, 2012

(54) Communication network management system and method and management computer

(75) Inventor: Satoshi Kamiya, Tokyo (JP)

(73) Assignee: NEC Corporation, Tokyo (JP)

(21) Appl. No.: 13/137,814

(22) Filed: Sep. 14, 2011

Related U.S. Application Data
(63) Continuation of application No. PCT/JP2010/059625, filed on Jun. 7, 2010.

(30) Foreign Application Priority Data
Jun. 8, 2009 (JP) 2009-137524

(51) Int. Cl. H04L 12/26

(52) U.S. Cl. 370/242

(57) ABSTRACT

A management computer includes a storage unit in which route information indicating a transfer route of frames in a communication network is stored; and a monitoring unit. First to N-th nodes (N is an integer not less than 2) line up in order along a transfer route. In identifying a location of failure on the transfer route, the monitoring unit transmits a state notification frame to the first node. The i-th node, when receiving the state notification frame, updates a forwarding table by adding the management computer to the forwarding destination and forwards the state notification frame to the (i+1)-th node. The i-th node, when receiving a check frame, forwards the check frame to the (i+1)-th node and the management computer by referring to the post-update forwarding table. The monitoring unit identifies the location of failure based on reception state of the check frame from the transfer route.

### CROSS-REFERENCE TO RELATED APPLICATION

This is a continuation of International Application No. PCT/JP2010/059625, filed on Jun. 7, 2010.

### TECHNICAL FIELD

The present invention relates to a communication network management technique that performs centralized management of a communication network by using a management computer.

### BACKGROUND ART

In recent years, a communication network has a significant role as a social infrastructure that provides various services, and failure of the communication network has an incalculable impact on users. Therefore, health-checking of the communication network has become a very important issue.

Patent Literature 1 (International Publication WO2005/048540) discloses a technique that uses a keep-alive frame to detect a failure in a communication network. More specifically, in a communication system in which a plurality of base nodes perform communication through one or more relay node, each base node transmits a keep-alive frame that is broadcasted by the relay node. Here, the plurality of base nodes mutually transmit and receive the keep-alive frame and detect failure by monitoring arrival state of the keep-alive frame transmitted from the other side node. In this case, in order to health-check all physical links in the communication network, it is necessary to configure a plurality of communication routes so as to cover all the physical links and to transmit and receive the keep-alive frame with respect to each communication route. That is, it is required to transmit and receive a large number of keep-alive frames. This causes increase in transmission and reception burden placed on each base node.

Non-Patent Literature 1 (S. Shah and M. Yip, “Extreme Networks' Ethernet Automatic Protection Switching (EAPS) Version 1”, The Internet Society, October 2003; (http://tools.ietf.org/html/rfc3619).) discloses a health-check technique in a communication network that is configured in a ring shape. In this case, a plurality of switches are connected through communication lines to form a ring shape, and one health-check frame is transferred sequentially along the ring. For example, a master switch on the ring transmits the health-check frame from a first port. Another switch forwards the received health-check frame to the next switch. The master switch receives the self-transmitted health-check frame at a second port, and thereby can confirm that no failure occurs. This technique assumes such a ring-shaped network structure and thus is not versatile.

Patent Literature 2 (Japanese Patent No. 3740982) discloses a technique that a management host computer performs health-check of a plurality of host computers. First, the management host computer determines an order of the health-check for the plurality of host computers. Next, the management host computer generates a health-check packet into which a health-check table is incorporated. The health-check table has a plurality of entries respectively related to the plurality of host computers, and the plurality of entries are arranged in the above determined order. Each entry includes an address of the related host computer and a check flag. Then, the management host computer transmits the health-check packet to a first host computer. A host computer that receives the health-check packet searches for the related entry in the health-check table and marks the check flag of the corresponding entry. After that, the host computer refers to the address in the next entry and transmits the health-check packet to the next host computer. Due to repetition of the above-mentioned processing, one health-check packet travels the host computers. Eventually, the management host computer receives the health-check packet that has traveled in this manner. Then, the management host computer determines that a failure occurs in a host computer the corresponding check flag of which is not marked.

According to Patent Literature 3 (Japanese Patent Publication JP-2006-332787), one health-check packet travels a plurality of monitor-target terminals, as in the case of Patent Literature 2. A similar health-check table is incorporated into the health-check packet. However, each entry includes, instead of the above-mentioned check flag, a check list in which such information as a date and time and an operating status is to be written. A monitoring terminal transmits the health-check packet to a first monitor-target terminal. When receiving the health-check packet, the monitor-target terminal judges whether or not itself is operating normally. In a case of a normal operation, the monitor-target terminal searches for the related entry in the health-check table and writes designated information such as the date and time and the operating status in the check list of the corresponding entry. Then, the monitor-target terminal refers to the address in the next entry and transmits the health-check packet to the next monitor-target terminal. Here, if communication with the next monitor-target terminal is impossible, the monitor-target terminal transmits the health-check packet to the monitor-target terminal after the next monitor-target terminal. Due to repetition of the above-mentioned processing, one health-check packet travels the monitor-target terminals. Eventually, the monitoring terminal receives the health-check packet that has traveled in this manner. If the designated information is not written in any check list, the monitoring terminal determines that a failure occurs.

It should be noted that Patent Literature 4 (Japanese Patent Publication JP-2000-48003), Patent Literature 5 (Japanese Patent Publication JP-H8-286920), Patent Literature 6 (Japanese Patent Publication JP-H11-212959) and Patent Literature 7 (Japanese Patent Publication JP-H3-191464) describe a method for solving a traveling salesman problem.

### CITATION LIST

### Patent Literature

[Patent Literature 1] International Publication WO2005/048540
[Patent Literature 2] Japanese Patent No. 3740982
[Patent Literature 3] Japanese Patent Publication JP-2006-332787
[Patent Literature 4] Japanese Patent Publication JP-2000-48003
[Patent Literature 5] Japanese Patent Publication JP-H8-286920
[Patent Literature 6] Japanese Patent Publication JP-H11-212959
[Patent Literature 7] Japanese Patent Publication JP-H3-191464

### Non-Patent Literature

[Non-Patent Literature 1] S. Shah and M. Yip, “Extreme Networks' Ethernet Automatic Protection Switching (EAPS) Version 1”, The Internet Society, October 2003; (http://tools.ietf.org/html/rfc3619).

### SUMMARY OF INVENTION

According to Patent Literature 3 described above, one health-check packet into which the health-check table is incorporated travels a plurality of nodes. When receiving the health-check packet, each node searches for the related entry in the health-check table and writes predetermined information such as the operating status in the corresponding entry. The predetermined information written in the health-check packet is used by the monitoring terminal for identifying location of failure. That is, the monitoring terminal performs identification of location of failure based on the predetermined information written in the health-check packet that comes back after traveling the plurality of nodes.

However, if communication between a node and the next node is not available, the traveling of the health-check packet is not achieved and thus the monitoring terminal cannot receive the health-check packet. That is, the monitoring terminal cannot perform the processing of identifying the location of failure. Therefore, a node that receives the health-check packet investigates whether or not it can communicate with the next node, before forwarding the health-check packet to the next node. More specifically, the node tries to connect a line with the next node for establishing handshake. If communication with the next node is impossible, the node searches for an available communication partner such as a node after the next node. Then, the node transmits the health-check packet to the available communication partner such as the node after the next node. However, such the processing is complicated and places overmuch burden on each node.

An object of the present invention is to provide a technique that, when performing centralized management of a communication network including a plurality of nodes by using a management computer, can speed up identification of a location of a failure without increasing burden placed on each node.

In an aspect of the present invention, a communication network management system is provided. The communication network management system has: a communication network; and a management computer that manages the communication network. The communication network includes a plurality of nodes and a plurality of links connecting between the plurality of nodes. Each of the plurality of nodes has a forwarding table that indicates a correspondence relationship between an input source and a forwarding destination of a frame.

The management computer has: a storage unit in which a route information indicating a transfer route of frames in the communication network is stored; and a monitoring unit. The monitoring unit refers to the route information to transmit a frame to the transfer route and performs identification processing that identifies a location of a failure on the transfer route. First to N-th nodes (N is an integer equal to or more than 2) line up in order along the transfer route. The i-th node (i=1 to N−1) forwards a received frame to the (i+1)-th node by referring to the forwarding table. The N-th node forwards a received frame to the management computer by referring to the forwarding table.

In the above-mentioned identification processing, the monitoring unit transmits a state notification frame to the first node. The i-th node, when receiving the state notification frame, updates the forwarding table by adding the management computer to the forwarding destination and forwards the received state notification frame to the (i+1)-th node through a physical link. Moreover, the i-th node, when receiving a check frame, forwards the received check frame to the (i+1)-th node and the management computer by referring to the forwarding table after the update. The monitoring unit identifies the location of the failure based on reception state of the check frame from the transfer route.

In another aspect of the present invention, a management computer that manages a communication network is provided. The communication network includes a plurality of nodes and a plurality of links connecting between the plurality of nodes. Each of the plurality of nodes has a forwarding table that indicates a correspondence relationship between an input source and a forwarding destination of a frame.

The management computer has: a storage unit in which a route information indicating a transfer route of frames in the communication network is stored; and a monitoring unit. The monitoring unit refers to the route information to transmit a frame to the transfer route and performs identification processing that identifies a location of a failure on the transfer route. First to N-th nodes (N is an integer equal to or more than 2) line up in order along the transfer route. The i-th node (i=1 to N−1) forwards a received frame to the (i+1)-th node by referring to the forwarding table. The N-th node forwards a received frame to the management computer by referring to the forwarding table.

In the above-mentioned identification processing, the monitoring unit transmits a state notification frame to the first node. The i-th node, when receiving the state notification frame, updates the forwarding table by adding the management computer to the forwarding destination and forwards the received state notification frame to the (i+1)-th node through a physical link. Moreover, the i-th node, when receiving a check frame, forwards the received check frame to the (i+1)-th node and the management computer by referring to the forwarding table after the update. The monitoring unit identifies the location of the failure based on reception state of the check frame from the transfer route.

In still another aspect of the present invention, a communication network management method that manages a communication network by using a management computer is provided. The communication network includes a plurality of nodes and a plurality of links connecting between the plurality of nodes. Each of the plurality of nodes has a forwarding table that indicates a correspondence relationship between an input source and a forwarding destination of a frame.

The communication network management method includes (A) transmitting a frame from the management computer to a transfer route of frames in the communication network. Here, first to N-th nodes (N is an integer equal to or more than 2) line up in order along the transfer route. The i-th node (i=1 to N−1) forwards a received frame to the (i+1)-th node by referring to the forwarding table. The N-th node forwards a received frame to the management computer by referring to the forwarding table.

The communication network management method further includes (B) identifying a location of a failure on the transfer route. The identifying includes: (B1) transmitting a state notification frame from the management computer to the first node; (B2) updating, in the i-th node that receives the state notification frame, the forwarding table by adding the management computer to the forwarding destination; (B3) forwarding the state notification frame from the i-th node to the (i+1)-th node through a physical link; (B4) forwarding a check frame from the i-th node receiving the check frame to the (i+1)-th node and the management computer in accordance with the forwarding table after the update; and (B5) identifying, by the management computer, the location of the failure based on reception state of the check frame from the transfer route.

According to the present invention, it is possible, when performing centralized management of a communication network including a plurality of nodes by using a management computer, to speed up identification of a location of a failure without increasing burden placed on each node.

### BRIEF DESCRIPTION OF DRAWINGS

The above and other objects, advantages and features of the present invention will be more apparent from the following description of certain exemplary embodiments taken in conjunction with the accompanying drawings.

FIG. 1 is a block diagram showing a configuration example of a communication network management system according to an exemplary embodiment of the present invention.

FIG. 2A shows frame forwarding processing in the communication network management system according to the present exemplary embodiment.

FIG. 2B shows failure location identification processing in the communication network management system according to the present exemplary embodiment.

FIG. 3 is a block diagram showing a configuration example of the communication network management system according to the present exemplary embodiment.

FIG. 4 is a flow chart showing a communication network management method according to the present exemplary embodiment.

FIG. 5 shows an example of a topology table.

FIG. 6 shows an example of a transfer route of check frames.

FIG. 7 shows an example of a route table.

FIG. 8 is a conceptual diagram showing an example of a check frame.

FIG. 9 shows a forwarding table of a switch 2.

FIG. 10 shows a forwarding table of a switch 3.

FIG. 11 shows a forwarding table of a switch 4.

FIG. 12 shows a forwarding table of a switch 5.

FIG. 13 shows frame forwarding processing at normal times.

FIG. 14 shows frame forwarding processing when a failure is occurring.

FIG. 15 is a flow chart showing failure location identification processing according to the present exemplary embodiment.

FIG. 16 shows a first example of the failure location identification processing.

FIG. 17 shows a post-update forwarding table of the switch 2.

FIG. 18 shows a post-update forwarding table of the switch 4.

FIG. 19 shows a check frame that is transmitted from the switch 2 to the management host.

FIG. 20 shows a check frame that is transmitted from the switch 4 to the management host.

FIG. 21 shows a post-update topology table.

FIG. 22 is a flow chart showing fault recovery processing.

FIG. 23 shows fault recovery processing in the case shown in FIG. 16.

FIG. 24 shows a second example of the failure location identification processing.

FIG. 25 shows fault recovery processing in the case shown in FIG. 24.

### DESCRIPTION OF EMBODIMENTS

### 1. Summary

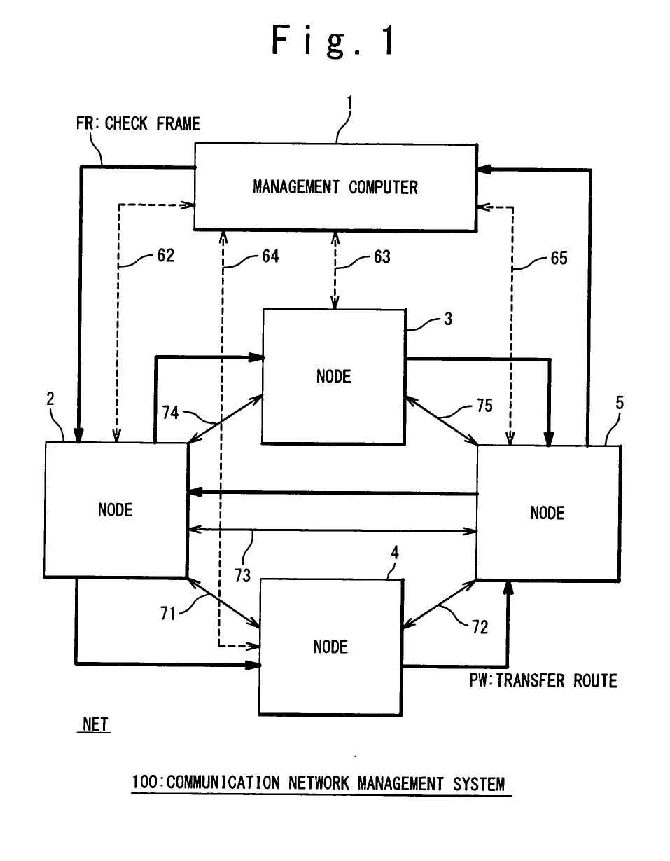

FIG. 1 schematically shows a configuration example of a communication network management system 100 according to an exemplary embodiment of the present invention. In the communication network management system 100, centralized management of a communication network is performed by a management computer. That is, the communication network management system 100 is provided with a communication network NET and a management computer 1 that manages the communication network NET, as shown in FIG. 1.

The communication network NET includes a plurality of nodes 2 to 5 and a plurality of physical links 71 to 75 connecting between the nodes 2 to 5. The physical link 71 is a signal line that bi-directionally connects the node 2 and the node 4. The node 2 and the node 4 can communicate bi-directionally through the physical link 71. The physical link 72 is a signal line that bi-directionally connects the node 4 and the node 5. The node 4 and the node 5 can communicate bi-directionally through the physical link 72. The physical link 73 is a signal line that bi-directionally connects the node 5 and the node 2. The node 5 and the node 2 can communicate bi-directionally through the physical link 73. The physical link 74 is a signal line that bi-directionally connects the node 2 and the node 3. The node 2 and the node 3 can communicate bi-directionally through the physical link 74. The physical link 75 is a signal line that bi-directionally connects the node 3 and the node 5. The node 3 and the node 5 can communicate bi-directionally through the physical link 75.

A control link 62 is a signal line that bi-directionally connects the management computer 1 and the node 2. A control link 63 is a signal line that bi-directionally connects the management computer 1 and the node 3. A control link 64 is a signal line that bi-directionally connects the management computer 1 and the node 4. A control link 65 is a signal line that bi-directionally connects the management computer 1 and the node 5. The management computer 1 and the nodes 2 to 5 can communicate bi-directionally through the control links 62 to 65, respectively.

The management computer 1 transmits a frame for health-check (hereinafter referred to as a “check frame FR”) to the communication network NET. The check frame FR goes through a certain transfer route PW in the communication network NET and comes back to the management computer 1. The transfer route PW of the check frame FR may be appropriately determined by the management computer 1 or may be fixed.

As an example, a transfer route PW along which the check frame FR travels in an order of “node 2-4-5-2-3-5” is shown in FIG. 1. In this case, the management computer 1 transmits the check frame FR to the node 2 through the control link 62. The node 2 forwards the received check frame FR to the subsequent node 4 through the physical link 71. The node 4 forwards the received check frame FR to the subsequent node 5 through the physical link 72. The node 5 forwards the received check frame FR to the subsequent node 2 through the physical link 73. The node 2 forwards the received check frame FR to the subsequent node 3 through the physical link 74. The node 3 forwards the received check frame FR to the subsequent node 5 through the physical link 75. In this manner, each node, when receiving the check frame FR, forwards the received check frame FR along the transfer route PW. Lastly, the node 5 forwards the received check frame FR to the management computer 1.

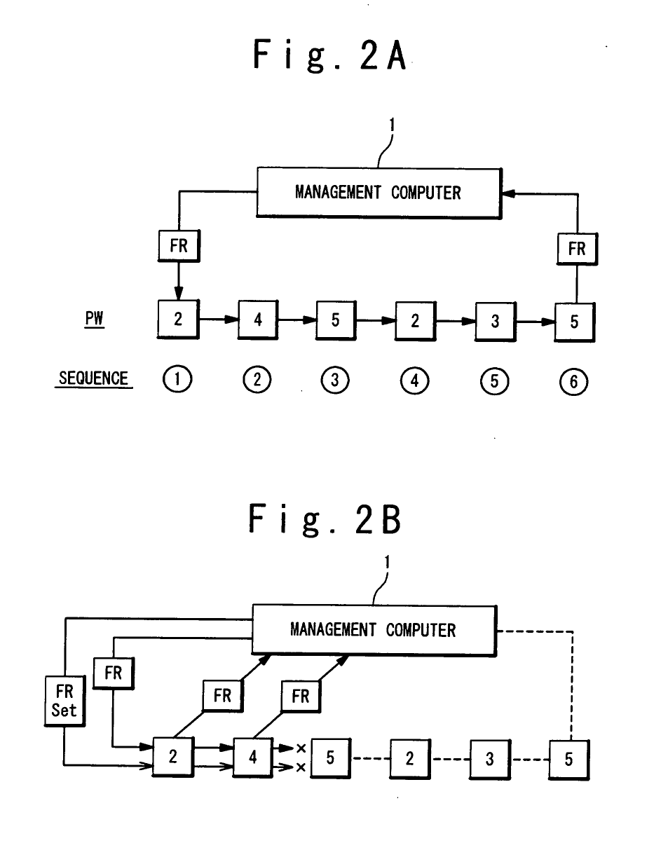

FIG. 2A shows in an easy-to-understand manner the travelling of the check frame FR shown in FIG. 1. N nodes line up in order on the transfer route PW of the check frame FR. The N is an integer equal to or more than 2. Hereinafter, the N nodes are respectively referred to as “first to N-th nodes” in an order along the transfer route PW. The first to N-th nodes may include a physically identical node for plural times. In the example shown in FIG. 2, N=6, the first node is the node 2, the second node is the node 4, the third node is the node 5, the fourth node is the node 2, the fifth node is the node 3, and the sixth node is the node 5.

At normal times, the management computer 1 transmits a check frame FR to the first node being a start-point of the transfer route PW. The i-th node (i=1 to N−1) on the transfer route PW, when receiving the check frame FR, forwards the received check frame FR to the (i+1)-th node. The N-th node, when receiving the check frame FR, forwards the received check frame FR to the management computer 1. In this manner, the travelling of the check frame FR is achieved.

In order to achieve such the traveling of the check frame FR along the transfer route PW in the communication network NET, each node is provided with a “forwarding table”. The forwarding table is a table that indicates a correspondence relationship between input sources and forwarding destinations of the check frames FR. Each node can forward the check frame FR received from an input source to a designated forwarding destination, by referring to the forwarding table.

Next, let us consider a case where a failure is occurring at some physical link on the transfer route PW. In this case, the management computer 1 carries out identification of location of the failure on the transfer route PW. The failure location identification processing in the present exemplary embodiment will be described with reference to FIG. 2B. As an example, let us consider a case where a failure is occurring at the physical link 72 from the second node (node 4) to the third node (node 5).

First, the management computer 1 transmits a “failure occurrence state notification frame FR-set” to the first node (node 2). The failure occurrence state notification frame FR-set is a frame for notifying each node of the failure occurrence. When receiving the failure occurrence state notification frame FR-set, the i-th node updates its own forwarding table by adding the management computer 1 to the forwarding destination indicated by the forwarding table. Further, the i-th node refers to the forwarding table to forward the received failure occurrence state notification frame FR-set to the subsequent (i+1)-th node through a physical link. That is, the failure occurrence state notification frame FR-set which serves as a trigger for updating the forwarding table is transferred in turn along the transfer route PW. In the example shown in FIG. 2B, the failure occurrence state notification frame FR-set reaches the first node and the second node in turn but does not reach the third node due to the failure occurrence after the second node. Therefore, the forwarding tables of the first node and the second node are updated.

After that, the first node refers to the forwarding table after the update to forward the received check frame FR not only to the subsequent second node but also to the management computer 1. Similarly, the second node refers to the forwarding table after the update to forward the received check frame FR not only to the subsequent third node but also to the management computer 1. However, since the failure is occurring at the physical link 72 between the second node and the third node, the check frame FR does not reach the third node. In other words, the travelling of the check frame FR ends through the first and second nodes.

The fact that the management computer 1 receives the check frame FR from the first and second nodes means that the check frame FR arrives at the second node but does not arrive at the third node. Therefore, the management computer 1 can identify the location of failure based on reception state of the check frame FR from the transfer route PW. More specifically, if the management computer 1 receives the check frame FR from a k-th node (k=1 to N−1) but fails to receive the check frame FR from a (k+1)-th node, the management computer 1 can determine that a failure is occurring at a physical link between the k-th node and the (k+1)-th node. In the example shown in FIG. 2B, the management computer 1 determines that a failure is occurring at the physical link 72 between the second node (node 4) and the third node (node 5).

In the failure location identification processing according to the present exemplary embodiment, each node just needs to copy the received check frame FR and forward them to both of the management computer 1 and the transfer route PW, after receiving the failure occurrence state notification frame FR-set. Each node needs not to write health-check information and the like to the check frame FR. Furthermore, the complicated processing such as required in Patent Literature 2 or Patent Literature 3 is not necessary for identifying the location of failure. For example, such processing as described in Patent Literature 3 that each node investigates whether or not it can communicate with the next node is not necessary. Consequently, burden placed on each node is greatly reduced. According to the present exemplary embodiment, it is possible to identify the location of failure on the transfer route PW with simple processing and to reduce burden placed on each node. Moreover, it is thereby possible to speed up the identification of the location of failure.

Furthermore, according to the present exemplary embodiment, there is no need to issue a “table change instruction” from the management computer 1 to all the nodes in order to change the forwarding table of each node after the failure occurrence is detected. According to the present exemplary embodiment, just one failure occurrence state notification frame FR-set that instructs to update the forwarding table needs to be transmitted from the management computer 1 to the first node of the transfer route PW. After that, the one failure occurrence state notification frame FR-set is transferred in turn along the transfer route PW up to ahead of the location of failure, and thereby the forwarding tables of necessary nodes are updated in turn. Since there is no need to issue a “table change instruction” from the management computer 1 to all the nodes, processing load on the management computer 1 can be reduced.

It should be noted that although the term “frame” is used in the above description, the same applies to a case of “packet (IP packet etc.)”.

The present invention can be applied to health-check of nodes and physical links on a LAN of companies, data centers, universities and the like and health-check of communication equipments and physical links of telecommunication carriers.

### 2. Concrete Example

Hereinafter, an exemplary embodiment of the present invention will be described in more detail.

First, contents of the forwarding table of each node are set up by each node in accordance with an instruction from the management computer 1. More specifically, the management computer 1 uses the control link (62, 63, 64, 65) to instruct each node (2, 3, 4, 5) to set up the forwarding table. Here, the management computer 1 instructs each node to set up the forwarding table such that the check frames FR are forwarded along the transfer route PW. Each node sets up the contents of the forwarding table in accordance with the instruction from the management computer 1.

Various interfaces are possible as an interface between the management computer and the nodes for achieving the processing described above. For example, Openflow (refer to http://www.openflowswitch.org/) is applicable. In this case, an “Openflow Controller” serves as the management computer 1 and an “Openflow Switch” serves as each of the nodes 2 to 5. It is possible to set up the forwarding table by using “Secure Channel” of the Openflow. Alternatively, GMPLS (Generalized Multi-Protocol Label Switching) also is applicable. In this case, the management computer instructs a GMPLS switch to set up the forwarding table. Alternatively, VLAN (Virtual LAN) also is applicable. In this case, the management computer can control VLAN setting of each switch by using an MIB (Management Information Base) interface.

In the following description, let us consider a case where the Openflow is used as the interface between the management computer and the nodes.

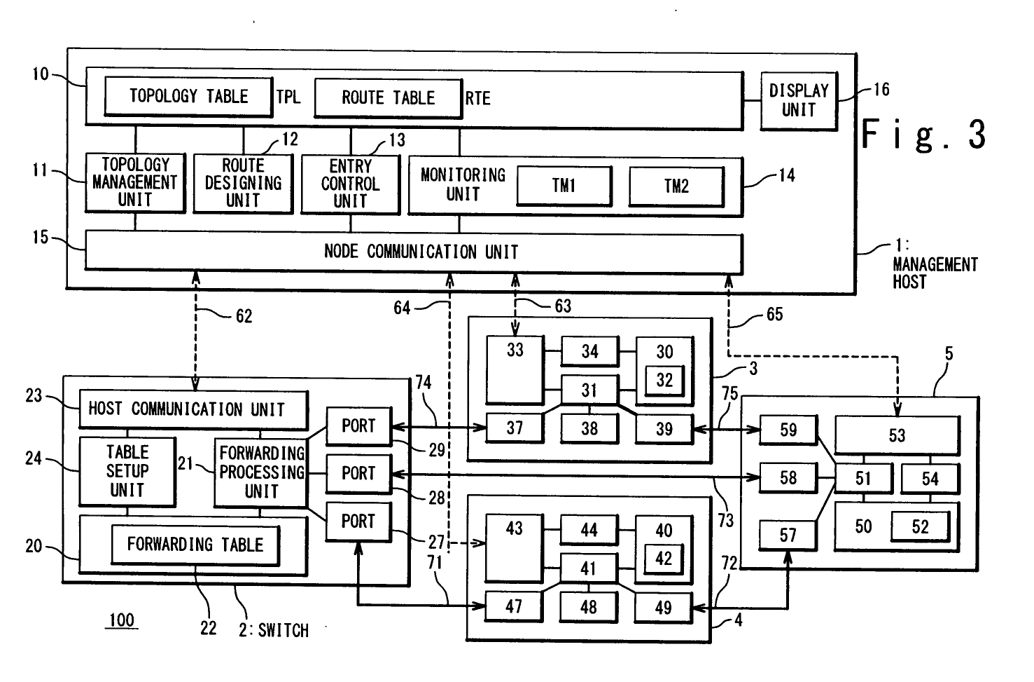

FIG. 3 is a block diagram showing a configuration example of the communication network management system 100 according to the present exemplary embodiment. A management host 1 (Openflow Controller) in FIG. 3 is equivalent to the management computer 1 in FIG. 1. Switches 2 to 5 (Openflow Switch) in FIG. 3 are equivalent to the nodes 2 to 5 in FIG. 1, respectively.

The management host 1 has a storage unit 10, a topology management unit 11, a route designing unit 12, an entry control unit 13, a monitoring unit 14, a node communication unit 15 and a display unit 16. The node communication unit 15 is connected to the switches 2 to 5 through the control links 62 to 65, respectively. The management host 1 can communicate bi-directionally with the switches 2 to 5 by using the node communication unit 15 and the control links 62 to 65.

The storage unit 10 is a storage device such as a RAM and an HDD. A topology table TPL, a route table RTE and the like are stored in the storage unit 10. The topology table TPL (topology information) indicates the above-mentioned physical topology of the communication network NET, namely, a connection relationship between the switches 2 to 5. The route table RTE (route information) indicates the transfer route PW of the check frames FR in the communication network NET.

The topology management unit 11 creates the topology table TPL and stores it in the storage unit 10. Moreover, the topology management unit 11 receives from the node communication unit 15 a topology change notification that is transmitted from each switch. Here, the topology change notification is information indicating change in the physical topology of the communication network NET and includes new switch connection information, up-down notification of a physical link and so forth. The topology management unit 11 updates the topology table TPL in accordance with the received topology change notification.

The route designing unit 12 refers to the topology table TPL stored in the storage unit 10 to determine (design) the transfer route PW of the check frame FR in the communication network NET. Then, the route designing unit 12 stores the route table RTE indicating the determined transfer route PW in the storage unit 10.

The entry control unit 13 instructs each switch (2, 3, 4, 5) to set up the forwarding table (22, 32, 42, 52). More specifically, the entry control unit 13 refers to the topology table TPL and the route table RTE stored in the storage unit 10. Then, the entry control unit 13 instructs each switch to set up the forwarding table such that the check frames FR are forwarded along the transfer route PW indicated by the route table RTE. The entry control unit 13 transmits a table setup command indicating the instruction to each switch (2, 3, 4, 5) through the node communication unit 15 and the control links (62, 63, 64, 65).

The monitoring unit 14 performs, based on the route table RTE stored in the storage unit 10, transmission and reception of the check frames FR to and from the communication network NET. The transmission and reception of the check frame FR to and from the switch 2 is performed through the node communication unit 15 and the control link 62. The transmission and reception of the check frame FR to and from the switch 3 is performed through the node communication unit 15 and the control link 63. The transmission and reception of the check frame FR to and from the switch 4 is performed through the node communication unit 15 and the control link 64. The transmission and reception of the check frame FR to and from the switch 5 is performed through the node communication unit 15 and the control link 65. Moreover, as will be described later in detail, the monitoring unit 14 detects a failure occurrence in the transfer route PW and performs processing of identifying a location of the failure.

It should be noted that the topology management unit 11, the route designing unit 12, the entry control unit 13 and the monitoring unit 14 described above can be realized by a processor executing a computer program.

The display unit 16 is a display device such as a liquid crystal display device. The display unit 16 displays various information. For example, the display unit 16 displays the connection state between the switches indicated by the topology table TPL and a state of failure occurrence that will be described below.

The switch 2 has a table storage unit 20, a forwarding processing unit 21, a host communication unit 23, a table setup unit 24, a port 27, a port 28 and a port 29. The host communication unit 23 corresponds to the “Secure Channel” of the “Openflow Switch”. The host communication unit 23 is connected to the management host 1 through the control link 62, and the switch 2 can communicate bi-directionally with the management host 1 by using the host communication unit 23 and the control link 62. Moreover, each port (communication interface) is connected to another switch through the physical link, and the switch 2 can communicate bi-directionally with another switch by using the port and the physical link.

The table storage unit 20 is a storage device such as a RAM and an HDD. The forwarding table 22 that indicates a correspondence relationship between input sources and forwarding destinations of the check frames FR is stored in the table storage unit 20.

The forwarding processing unit 21 receives the check frame FR from the host communication unit 23 (i.e. management host 1). Alternatively, the forwarding processing unit 21 receives the check frame FR from any port (i.e. another switch). Then, by referring to the forwarding table 22 stored in the table storage unit 20, the forwarding processing unit 2 forwards the check frame FR received from an input source to a forwarding destination (host communication unit 23 or port) designated by the forwarding table 22. In a case where a plurality of forwarding destinations are designated, the forwarding processing unit 21 copies the check frame FR and forwards them respectively to the plurality of forwarding destinations. It should be noted the above-mentioned failure occurrence state notification frame FR-set and a failure occurrence state end notification frame FR-reset that will be described later both are kinds of the check frame FR. In cases of the failure occurrence state notification frame FR-set and the failure occurrence state end notification frame FR-reset, the forwarding processing unit 21 instructs the table setup unit 24 to change (update) the forwarding table 22.

The table setup unit 24 receives from the host communication unit 23 the above-mentioned table setup command transmitted from the management host 1. Then, in accordance with the table setup command, the table setup unit 24 sets (add, delete, change) the contents of the forwarding table 22 stored in the table storage unit 20. There is also a case where the table setup unit 24 receives a forwarding table setup command from the forwarding processing unit 21 in response to the failure occurrence state notification frame FR-set and the failure occurrence state end notification frame FR-reset. Also in this case, the table setup unit 24 sets (add, delete, change) the contents of the forwarding table 22. More specifically, in the case of the failure occurrence state notification frame FR-set, the table setup unit 24 adds the management host 1 to the forwarding destination of the check frame FR. On the other hand, in the case of the failure occurrence state end notification frame FR-reset, the table setup unit 24 deletes the added forwarding destination mentioned above to restore the forwarding table 22.

Other switches 3 to 5 each has a similar configuration to that of the switch 2. That is, the switch 3 has a table storage unit 30, a forwarding processing unit 31, a host communication unit 33, a table setup unit 34, a port 37, a port 38 and a port 39. A forwarding table 32 is stored in the table storage unit 30. The switch 4 has a table storage unit 40, a forwarding processing unit 41, a host communication unit 43, a table setup unit 44, a port 47, a port 48 and a port 49. A forwarding table 42 is stored in the table storage unit 40. The switch 5 has a table storage unit 50, a forwarding processing unit 51, a host communication unit 53, a table setup unit 54, a port 57, a port 58 and a port 59. A forwarding table 52 is stored in the table storage unit 50. Each component and processing are the same as in the case of the switch 2, and description thereof is omitted.

In the example shown in FIG. 3, the physical topology of the communication network NET, namely, the connection relationship between the switches 2 to 5 is as follows. The port 27 of the switch 2 and the port 47 of the switch 4 are connected bi-directionally through the physical link 71. The port 49 of the switch 4 and the port 57 of the switch 5 are connected bi-directionally through the physical link 72. The port 58 of the switch 5 and the port 28 of the switch 2 are connected bi-directionally through the physical link 73. The port 29 of the switch 2 and the port 37 of the switch 3 are connected bi-directionally through the physical link 74. The port 39 of the switch 3 and the port 59 of the switch 5 are connected bi-directionally through the physical link 75.

### 3. Detection of Failure Occurrence

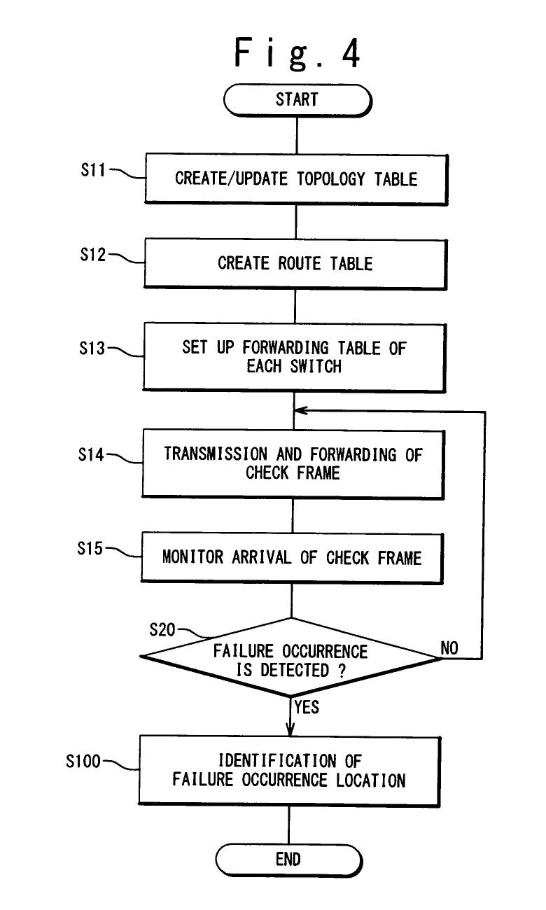

FIG. 4 is a flow chart showing a communication network management method according to the present exemplary embodiment. The communication network management processing according to the present exemplary embodiment will be described in detail with reference to FIGS. 3 and 4 as appropriate. It should be noted that management processing by the management host 1 is realized by the management host 1 executing a management program. Also, frame forwarding processing by each switch is realized by the each switch executing a frame forwarding program.

Step S11:

The topology management unit 11 creates the topology table TPL and stores it in the storage unit 10. Moreover, the topology management unit 11 receives the topology change notification from each switch and updates the topology table TPL in accordance with the topology change notification.

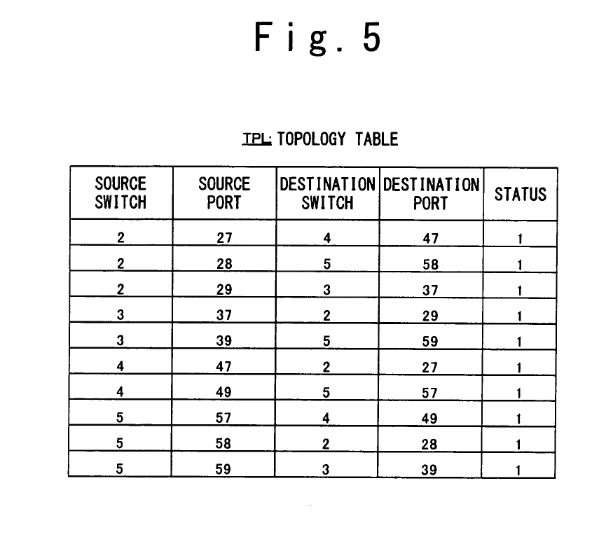

Here, let us consider a case where the physical topology of the communication network NET is as shown in FIG. 3. FIG. 5 shows an example of the topology table TPL in that case. The topology table TPL has a plurality of entries that are respectively related to a plurality of physical links 71 to 75. In the case where the physical link is bi-directional, the entry is created with respect to each direction. Each entry indicates a source switch, a source port, a destination switch, a destination port and a status flag with regard to the related physical link. The source switch is a switch as a start-point of the physical link, and the source port is a port of the source switch. The destination switch is a switch as an end-point of the physical link, and the destination port is a port of the destination switch. For example, the first entry “source switch=2, source port=27, destination switch=4, destination port=47” in FIG. 5 is related to the physical link 71 from the switch 2 toward the switch 4. The same applies to the other entries.

The status flag included in each entry indicates whether the related physical link is available or not. If validity of a physical link is confirmed, the status flag of the entry related to the physical link is set to “1 (available)”. On the other hand, if validity of a physical link is not yet confirmed or a failure is occurring at the physical link, the status flag of the entry related to the physical link is set to “0 (not available)”. In the example shown in FIG. 5, the status flags of all the entries are “1”.

Step S12:

The route designing unit 12 refers to the physical topology indicated by the above-mentioned topology table TPL to determine (design) the transfer route PW of the check frame FR. Then, the route designing unit 12 creates the route table RTE indicating the determined transfer route PW and stores it in the storage unit 10.

Here, the route designing unit 12 may determine the transfer route PW such that all of the physical links 71 to 75 is traversable by the transfer route PW. When determining the traversable route, an algorithm for solving the traveling salesman problem (for example, refer to Patent Literature 4, Patent Literature 5, Patent Literature 6 and Patent Literature 7) can be used. In this case, each physical link corresponds to a “destination to visit by a salesman in the traveling salesman problem”.

Moreover, the transfer route PW may not be a complete traversable route. The transfer route PW may be determined such that the check frame FR travels as many physical links as possible. Alternatively, all the physical links 71 to 75 may be covered by combining a plurality of traversable routes. In this case, successive route IDs such as “00”, “01”, “02” . . . are given to the respective traversable routes.

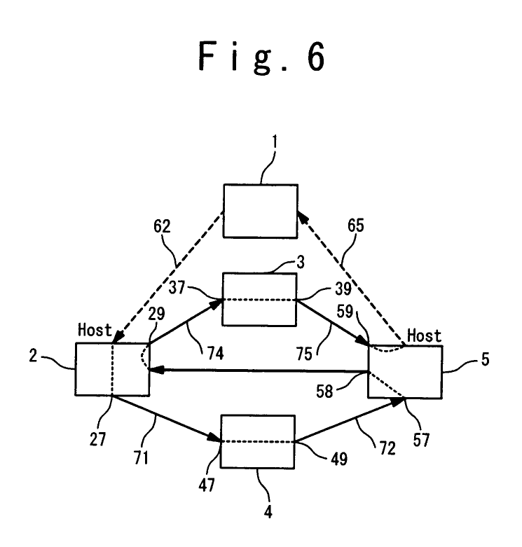

FIG. 6 shows an example of the transfer route PW with which the physical links 71 to 75 are traversable. In the case of the transfer route PW shown in FIG. 6, the switch 2 (first switch), the physical link 71, the switch 4 (second switch), the physical link 72, the switch 5 (third switch), the physical link 73, the switch 2 (fourth switch), the physical link 74, the switch 3 (fifth switch), the physical link 75 and the switch 5 (sixth switch) are connected in this order. The check frame FR is transferred along this transfer route PW.

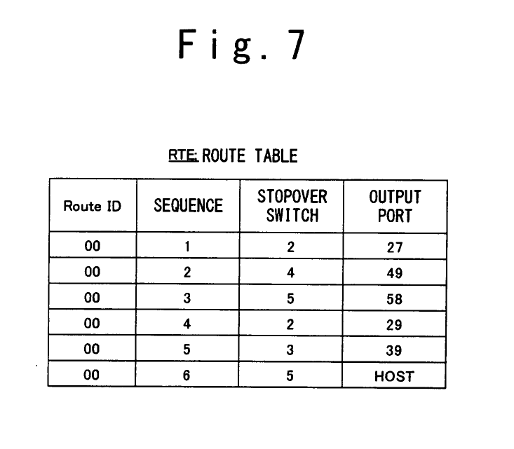

FIG. 7 shows an example of the route table RTE in the case of the transfer route PW shown in FIG. 6. The route table RTE has a plurality of entries that indicate in order the transfer route PW shown in FIG. 6. Each entry indicates the route ID, a stopover switch and an output port. The route ID is an ID that is given with respect to each transfer route PW.

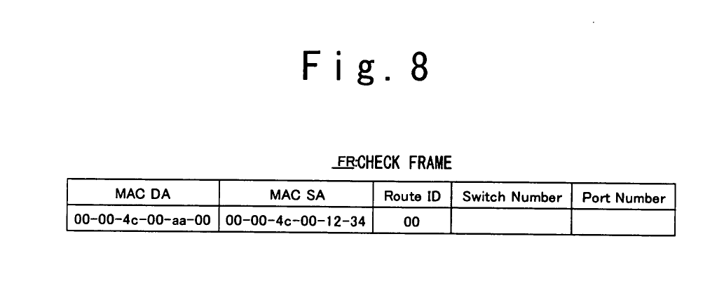

FIG. 8 is a conceptual diagram showing an example of the check frame FR. The check frame FR has information on a destination MAC address (MAC DA), a source MAC address (MAC SA), the route ID, a switch number (Switch Number) and an input port number (Port Number). In the present exemplary embodiment, the destination MAC address is used for distinguishing the check frame FR. The setting of the destination MAC address is arbitrary as long as the check frame FR can be distinguished. For example, the destination MAC address is set to “00-00-4c-00-aa-00”. The source MAC address is set to a MAC address “00-00-4c-00-12-34” of the management host 1. The route ID is an ID that is given with respect to each transfer route PW, as described above. The switch number and the input port number are written when the check frame FR is sent back to the management host 1. The switch number is a number (ID number) of the sending source of the check frame FR, i.e. the node itself. The input port number is a port number of the input port to which the check frame FR is input. For example, in a case where the switch 4 receives a check frame FR through the port 47 and returns the check frame FR back to the management host 1, the switch number is set to “4” and the input port number is set to “47”. It should be noted that the switch number and the input port number are not necessarily necessary.

Step S13:

The entry control unit 13 of the management host 1 instructs the table setup unit of each of the switches 2 to 5 to set up each forwarding table. At this time, the entry control unit 13 refers to the topology table TPL and the route table RTE stored in the storage unit 10. Then, the entry control unit 13 determines contents of the instruction such that the check frame FR is forwarded along the transfer route PW indicated by the route table RTE. The table setup command indicating the instruction is transmitted from the entry control unit 13 to each switch (2, 3, 4, 5) through the node communication unit 15 and the control link (62, 63, 64, 65).

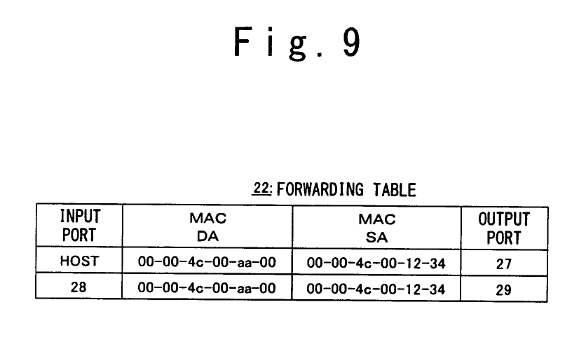

In the switch 2, the table setup unit 24 receives the table setup command from the host communication unit 23. Then, the table setup unit 24 sets, in accordance with the table setup command, the contents of the forwarding table 22 stored in the table storage unit 20. FIG. 9 shows an example of the forwarding table 22 in the case of the transfer route PW shown in FIG. 6. The forwarding table 22 indicates an input port, the destination MAC address (MAC DA), the source MAC address (MAC SA) and an output port.

The input port indicates the input source (port or host communication unit 23) to which the check frame FR is input. If the input source is any port (i.e. another switch), the input port is expressed by its port number. If the input source is the host communication unit 23 (i.e. the management host 1), the input port is expressed by “HOST”.

The output port indicates the forwarding destination (port or host communication unit 23) to which the check frame FR is forwarded. If the forwarding destination is any port (i.e. another switch), the output port is expressed by its port number. If the forwarding destination is the host communication unit 23 (i.e. management host 1), the output port is expressed by “HOST”. It should be noted that a plurality of output ports may be set with respect to one entry. In this case, the check frame FR is output to the respective output ports.

The destination MAC address in the forwarding table 22 is the same as the above-mentioned destination MAC address in the check frame FR. In the present example, the destination MAC address is “00-00-4c-00-aa-00”. Moreover, the source MAC address in the forwarding table 22 is the same as the above-mentioned source MAC address in the check frame FR. In the present example, the source MAC address is the MAC address “00-00-4c-00-12-34” of the management host 1. It should be noted that the source MAC address may be omitted if only one management host 1 is used.

As described above, the forwarding table 22 includes the input source (input port), the forwarding destination (output port) and header information (MAC DA, MAC SA and the like) regarding the check frame FR. In other words, the forwarding table 22 indicates a correspondence relationship between the input source, the header information and the forwarding destination with regard to the check frame FR. By referring to such the forwarding table 22, the forwarding processing unit 21 is able to forward the received check frame FR to the designated forwarding destination. At this time, the input port and the header information (MAC DA, MAC SA) are used as a search keyword for the associated output port. As an example, let us consider a case where the forwarding processing unit 21 receives the check frame FR (MAC DA=00-00-4c-00-aa-00, MAC SA=00-00-4c-00-12-34) from the host communication unit 23 (input port=HOST). In this case, the first entry in the forwarding table 22 becomes a hit entry. Therefore, the forwarding processing unit 21 forwards the check frame FR to the output port 27 indicated by the hit entry. That is, the check frame FR transmitted from the management host 1 is output to the physical link 71 connected to the output port 27 and thus forwarded to the switch 4. In this manner, the forwarding of the check frame FR is achieved. The same applies to the failure occurrence state notification frame FR-set and the failure occurrence state end notification frame FR-reset.

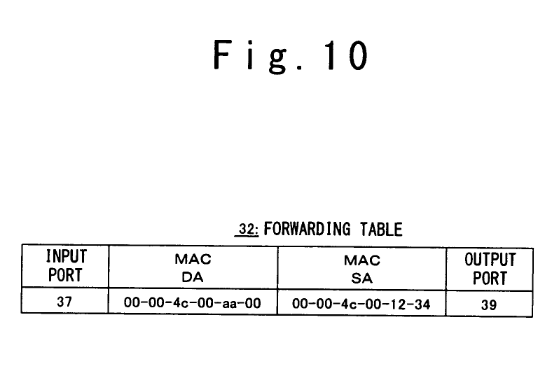

In the switch 3, the table setup unit 34 receives the table setup command from the host communication unit 33. Then, the table setup unit 34 sets, in accordance with the table setup command, the contents of the forwarding table 32 stored in the table storage unit 30. FIG. 10 shows the forwarding table 32 in the present example.

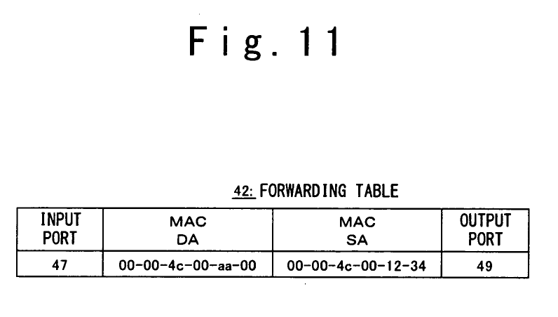

In the switch 4, the table setup unit 44 receives the table setup command from the host communication unit 43. Then, the table setup unit 44 sets, in accordance with the table setup command, the contents of the forwarding table 42 stored in the table storage unit 40. FIG. 11 shows the forwarding table 42 in the present example.

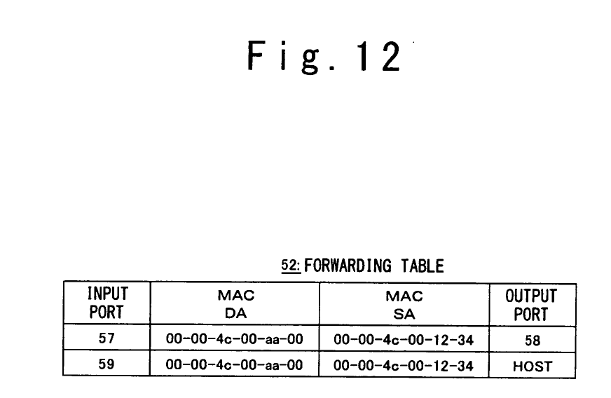

In the switch 5, the table setup unit 54 receives the table setup command from the host communication unit 53. Then, the table setup unit 54 sets, in accordance with the table setup command, the contents of the forwarding table 52 stored in the table storage unit 50. FIG. 12 shows the forwarding table 52 in the present example.

Step S14:

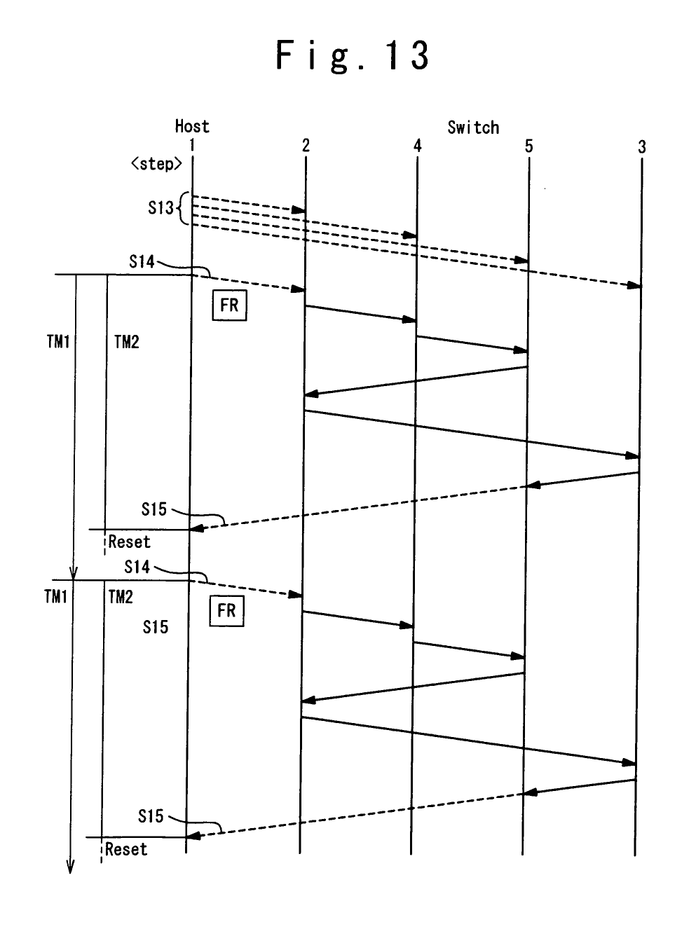

After the Step S13 is completed, the monitoring unit 14 of the management host 1 periodically performs transmission of the check frame FR. The forwarding processing unit of each switch, when receiving the check frame FR, forwards the check frame FR. FIG. 13 shows transmission and forwarding processing of the check frame FR at normal times. In FIG. 13, dashed arrows indicate communications by using the control links 62 to 65, and solid arrows indicate communications by using the physical links 71 to 75.

First, the monitoring unit 14 generates a check frame FR as shown in FIG. 8. Subsequently, the monitoring unit 14 refers to the route table RTE shown in FIG. 7 to transmit the check frame FR to the first switch on the transfer route PW, i.e. the switch 2 (first switch). At this time, the switch number of the check frame FR for transmission is set to a host number. Also, the input port number thereof is set to a number that is not used in each switch. Moreover, the monitoring unit 14 starts a first timer TM1 and a second timer TM2 at the same time as the transmission of the check frame FR. The first timer TM1 is used for performing the periodical transmission of the check frame FR. That is, the monitoring unit 14 performs the transmission of the check frame FR at a predetermined interval counted by the first timer TM1. The second timer TM2 is used for processing of detecting failure occurrence which will be described later. A set time of the second timer TM2 is substantially longer than a set time of the first timer TM1.

The check frame FR is transmitted from the node communication unit 15 of the management host 1 through the control link 62 to reach the host communication unit 23 of the switch 2 (first switch). The forwarding processing unit 21 receives the check frame FR from the host communication unit 23. The forwarding processing unit 21 refers to the forwarding table 22 shown in FIG. 9 to forward the received check frame FR to the port 27 (i.e. switch 4).

The check frame FR is transmitted from the port 27 of the switch 2 through the physical link 71 to reach the port 47 of the switch 4 (second switch). The forwarding processing unit 41 receives the check frame FR from the port 47. The forwarding processing unit 41 refers to the forwarding table 42 shown in FIG. 11 to forward the received check frame FR to the port 49 (i.e. switch 5).

The check frame FR is transmitted from the port 49 of the switch 4 through the physical link 72 to reach the port 57 of the switch 5 (third switch). The forwarding processing unit 51 receives the check frame FR from the port 57. The forwarding processing unit 51 refers to the forwarding table 52 shown in FIG. 12 to forward the received check frame FR to the port 58 (i.e. switch 2).

The check frame FR is transmitted from the port 58 of the switch 5 through the physical link 73 to reach the port 28 of the switch 2 (fourth switch). The forwarding processing unit 21 receives the check frame FR from the port 28. The forwarding processing unit 21 refers to the forwarding table 22 shown in FIG. 9 to forward the received check frame FR to the port 29 (i.e. switch 3).

The check frame FR is transmitted from the port 29 of the switch 2 through the physical link 74 to reach the port 37 of the switch 3 (fifth switch). The forwarding processing unit 31 receives the check frame FR from the port 37. The forwarding processing unit 31 refers to the forwarding table 32 shown in FIG. 10 to forward the received check frame FR to the port 39 (i.e. switch 5).

The check frame FR is transmitted from the port 39 of the switch 3 through the physical link 75 to reach the port 59 of the switch 5 (sixth switch). The forwarding processing unit 51 receives the check frame FR from the port 59. The forwarding processing unit 51 refers to the forwarding table 52 shown in FIG. 12 to forward the received check frame FR to the host communication unit 53 (i.e. management host 1).

The check frame FR is transmitted from the host communication unit 53 of the switch 5 (sixth switch) through the control link 65 to reach the node communication unit 15 of the management host 1. In this manner, the transfer (travel) of the check frame FR along the transfer route PW is achieved.

Step S15:

The monitoring unit 14 of the management host 1 monitors arrival of the check frame FR. In the case of the example shown in FIG. 13, the check frame FR returns back to the management host 1 from the switch 5 (sixth switch) without being lost on the way. In this case, the monitoring unit 14 receives the check frame FR before the sufficiently long second timer TM2 expires. That is, the monitoring unit 14 receives the check frame FR from the sixth switch within a predetermined period of time counted by the second timer TM2 after transmitting the check frame FR to the first switch. In this case, the monitoring unit 14 resets the second timer TM2 and determines that no failure is occurring on the transfer route PW (Step S20; No).

After that, when the first timer TM1 expires, the monitoring unit 14 transmits a new check frame FR. Then, the Steps S14 and S15 are repeated. In this manner, at normal times, the check frame FR periodically travels the transfer route PW and whether or not a failure is occurring is judged every travel.

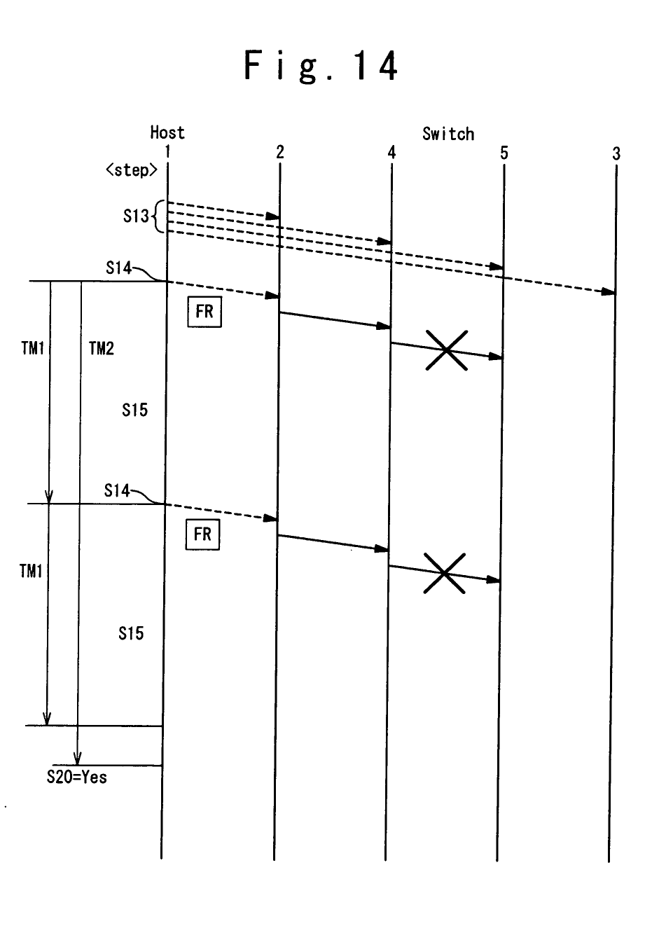

FIG. 14 shows a case where a failure is occurring at a part of the transfer route PW. As an example, let us consider a case where a failure occurs at the physical link 72 between the switch 4 and the switch 5 and the bi-directional communication there becomes impossible. As in the case of FIG. 13, the monitoring unit 14 periodically transmits the check frame FR. However, since the failure occurs at the physical link 72, the check frame FR is not transferred from the switch 4 to the switch 5. Therefore, the second timer TM2 expires without the monitoring unit 14 receiving the check frame FR. That is, the monitoring unit 14 does not receive the check frame FR from the sixth switch within a predetermined period of time counted by the second timer TM2 after transmitting the check frame FR to the first switch. In this case, the monitoring unit 14 determines that a failure is occurring somewhere on the transfer route PW (Step S20; Yes).

In this manner, the monitoring unit 14 can detect failure occurrence on the transfer route PW by monitoring reception state of the check frame FR. When the failure occurrence is detected, the monitoring unit 14 instructs the display unit 16 to display that effect. The display unit 16 displays the physical topology indicated by the topology table TPL, the transfer route PW indicated by the route table RTE and the failure occurrence on the transfer route PW. If the failure occurrence is detected by the monitoring unit 14, the processing proceeds to identification of location of the failure (Step S100).

### 4. Identification of Location of Failure (Step S100)

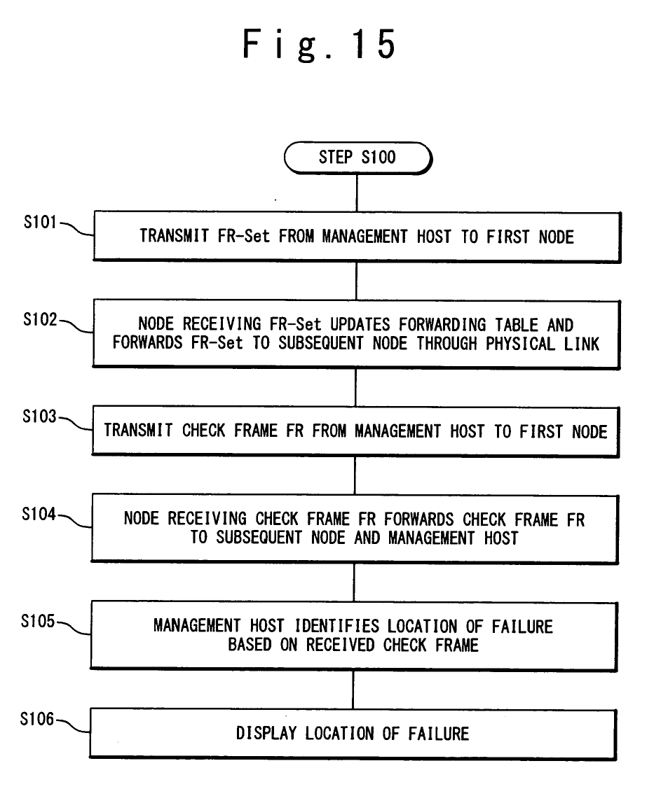

Hereinafter, the Step S100 in the present exemplary embodiment will be described. FIG. 15 is a flow chart showing the Step S100. As an example, let us consider a case where the location of failure is the physical link 72 from the second switch (switch 4) toward the third switch (switch 5).

### 4-1. First Example

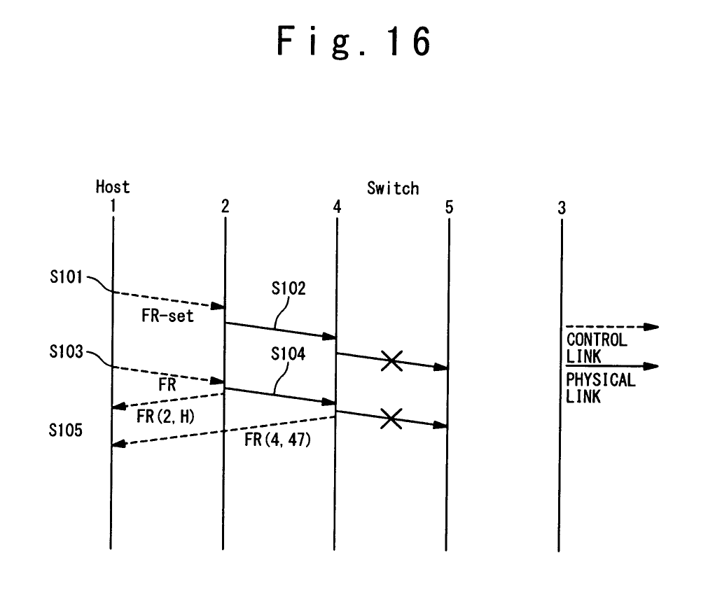

FIG. 16 shows frame forwarding in a case of a first example.

Step S101:

After the monitoring unit 14 detects the failure occurrence, the monitoring unit 14 transmits a failure occurrence state notification frame FR-set to the first switch (switch 2).

Step S102:

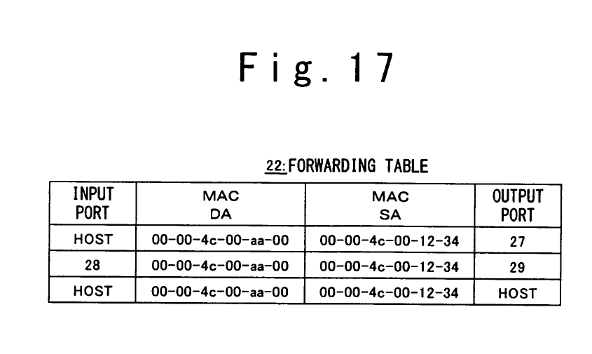

The switch 2 receives the failure occurrence state notification frame FR-set from the management host 1 and updates its own forwarding table 22. FIG. 17 shows the forwarding table 22 after the update. As compared with that shown in FIG. 9, a new entry “input port: HOST, MAC DA: 00-00-4c-00-aa-00, MAC SA: 00-00-4c-00-12-34, output port: HOST” is added. Furthermore, the switch 2 forwards the failure occurrence state notification frame FR-set to the subsequent switch 4 through the physical link 71, as in the case of the usual check frame FR.

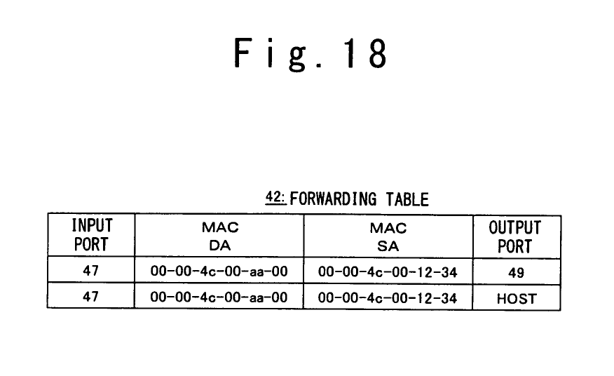

The switch 4 receives the failure occurrence state notification frame FR-set from the switch 2 through the physical link 71 and updates its own forwarding table 42. FIG. 18 shows the forwarding table 42 after the update. As compared with that shown in FIG. 11, a new entry “input port: 47, MAC DA: 00-00-4c-00-aa-00, MAC SA: 00-00-4c-00-12-34, output port: HOST” is added. Furthermore, the switch 4 forwards the failure occurrence state notification frame FR-set to the subsequent switch 5 through the physical link 72, as in the case of the usual check frame FR.

However, in the present example, the failure is occurring at the physical link 72. Therefore, the failure occurrence state notification frame FR-set does not arrive at the switch 5. Thus, the forwarding tables of the rest of the switches are not changed.

Step S103:

After the updating of the forwarding table is completed, the monitoring unit 14 transmits a check frame FR to the first switch (switch 2). The monitoring unit 14 may periodically carry out the transmission of the check frame FR.

Step S104:

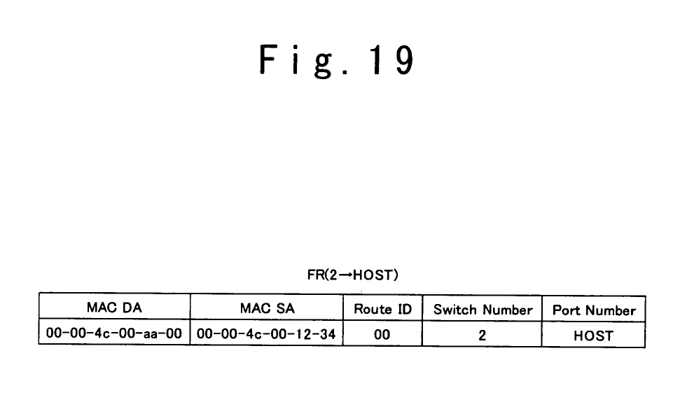

The switch 2 receives the check frame FR from the management host 1 (HOST). The switch 2 refers to the forwarding table 22 shown in FIG. 17 to forward the check frame FR to the subsequent switch 4 (port 27) and the management host 1 (HOST). FIG. 19 shows the check frame FR that is transmitted from the switch 2 to the management host 1. As shown in FIG. 19, the switch number is set to “2”, and the input port number is set to “HOST”.

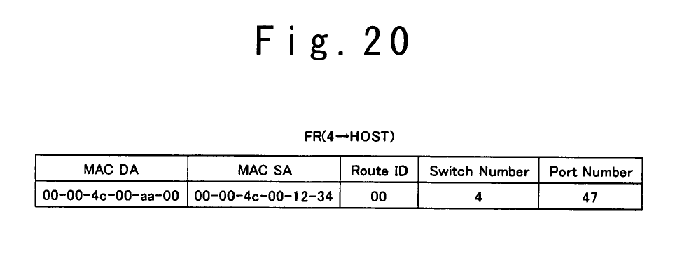

The switch 4 receives the check frame FR from the switch 2 (port 47). The switch 4 refers to the forwarding table 42 shown in FIG. 18 to forward the check frame FR to the subsequent switch 5 (port 49) and the management host 1 (HOST). FIG. 20 shows the check frame FR that is transmitted from the switch 4 to the management host 1. As shown in FIG. 20, the switch number is set to “4”, and the input port number is set to “47”.

In the present example, a failure is occurring at the physical link 72 from the switch 4 toward the switch 5. Therefore, the check frame FR is not transferred to and after the switch 5, and no check frame FR other than those described above comes back to the management host 1.

Step S105:

The monitoring unit 14 receives the check frame FR shown in FIG. 19 from the switch 2, receives the check frame FR shown in FIG. 20 from the switch 4 but fails to receive from the subsequent switches. Therefore, the monitoring unit 14 can recognize by referring to the route table RTE (see FIG. 7) that “the check frame FR normally arrives at the first and second switches but does not arrive at the subsequent switches”. That is, the monitoring unit 14 determines that the failure is occurring at the physical link 72 from the second switch (switch 4) to the third switch (switch 5).

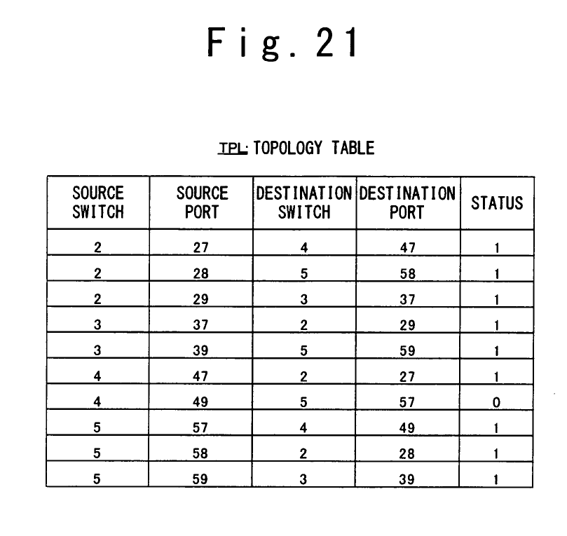

When the location of failure is identified, the monitoring unit 14 updates the status flag in the topology table TPL stored in the storage unit 10. In the present example, as shown in FIG. 21, the status flag of the entry “source switch=4, source port=49, end-point switch=5, end-point port=57” associated with the physical link 72 from the switch 4 to the switch 5 is updated to “0 (not available)”.

Step S106:

The monitoring unit 14 instructs the display unit 16 to display the identified location of failure. The display unit 16 refers to the topology table TPL and displays the link whose status flag is “0” as the location of failure.

According to the first example, the location of failure can be identified by the transmission of two frames from the management host 1 and the frame reception by each switch for (N−1)/2 times on average and N−1 times at a maximum.

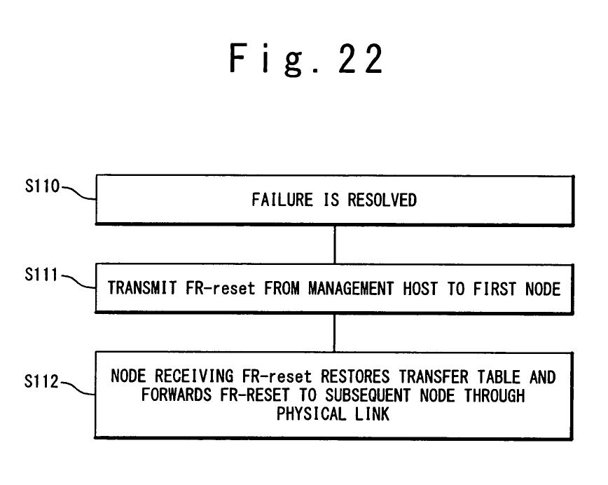

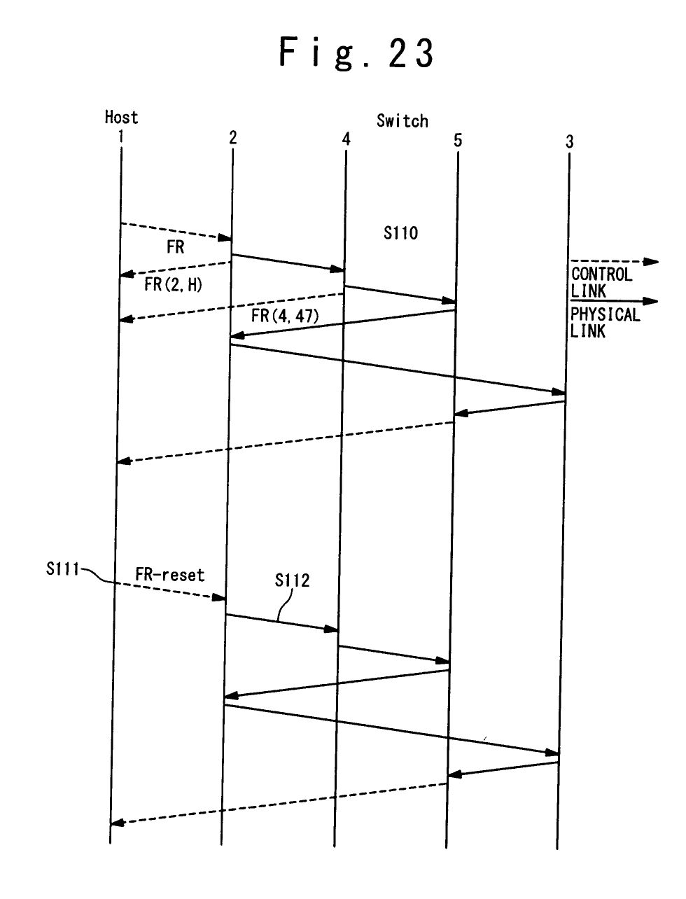

It should be noted that each forwarding table may be restored to its former state, after the failure is resolved. FIG. 22 is a flow chart showing an example of fault recovery processing. FIG. 23 shows an example of fault recovery processing in the case shown in FIG. 16.

Step S110:

The monitoring unit 14 periodically transmits the check frame FR. If the failure at the physical link 72 between the switch 4 and the switch 5 is resolved, the check frame FR arrives at the last switch (the N-th switch=switch 5) and returns back to the management host 1. Thereby, the monitoring unit 14 determines that the failure has been resolved.

Step S111:

The monitoring unit 14 transmits a failure occurrence state end notification frame FR-reset to the first switch (switch 2).

Step S112:

The switch 2 receives the failure occurrence state end notification frame FR-reset from the management host 1 and, in response to that, restores its own forwarding table 22 to that shown in FIG. 9. Furthermore, the switch 2 forwards the failure occurrence state end notification frame FR-reset to the subsequent switch 4 through the physical link 71. The switch 4 receives the failure occurrence state end notification frame FR-reset from the switch 2 and, in response to that, restores its own forwarding table 42 to that shown in FIG. 11. Furthermore, the switch 4 forwards the failure occurrence state end notification frame FR-reset to the subsequent switch 5 through the physical link 72.

After that, the failure occurrence state end notification frame FR-reset is forwarded in turn along the transfer route PW and eventually returns from the last switch (the N-th switch=switch 5) back to the management host 1. Thereby, the monitoring unit 14 confirms that the recovery of each forwarding table is completed. Then, the monitoring unit 14 restores the status flag in the topology table TPL stored in the storage unit 10. The topology table TPL is restored to that shown in FIG. 5.

### 4-2. Second Example

In a second example, the function of the check frame FR is added to the failure occurrence state notification frame FR-set. In other words, the failure occurrence state notification frame FR-set also plays a role of the check frame FR in the above-described first example, and each switch receives the failure occurrence state notification frame FR-set as the check frame FR. The switch, when receiving the failure occurrence state notification frame FR-set, updates its own forwarding table and further forwards the failure occurrence state notification frame FR-set to both of the subsequent switch and the management host 1 by referring to the forwarding table after the update.

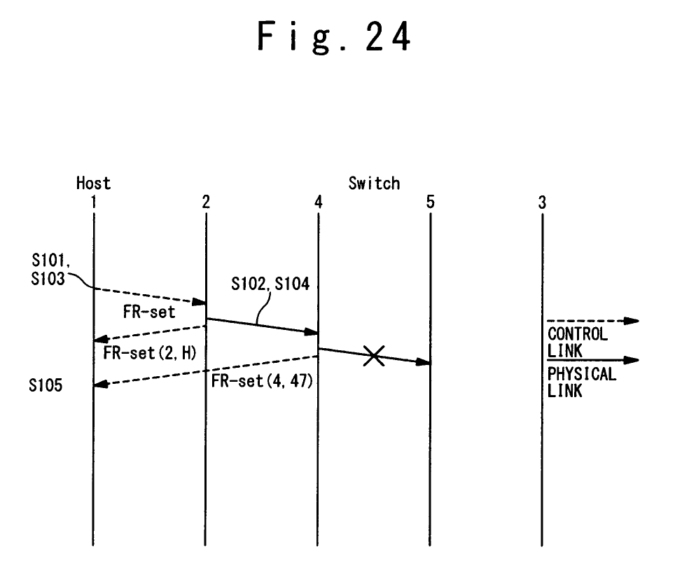

FIG. 24 shows frame forwarding in the case of the second example. The above-described Step S101 and Step S103 are executed concurrently. That is, the monitoring unit 14 transmits the failure occurrence state notification frame FR-set as the check frame FR to the first switch (switch 2). Moreover, the above-described Step S102 and Step S104 are executed concurrently. That is, the switch 2 updates its forwarding table 22 (see FIG. 17) and forwards the failure occurrence state notification frame FR-set to the subsequent switch 4 and the management host 1 (see FIG. 19). Also, the switch 4 updates its forwarding table 42 (see FIG. 18) and forwards the failure occurrence state notification frame FR-set to the subsequent switch 5 and the management host 1 (see FIG. 20). Since the failure is occurring at the physical link 72 from the switch 4 to the switch 5, the failure occurrence state notification frame FR-set does not arrive at the switch 5. The Steps S105 and S106 are the same as in the case of the first example.

According to the second example, the location of failure can be identified by the transmission of one frame from the management host 1 and the frame reception by each switch for (N−1)/2 times on average and N−1 times at a maximum. The number of frames transmitted from the management host 1 for identifying the location of failure is reduced as compared with the first example. Therefore, a time required for identifying the location of failure is further reduced.

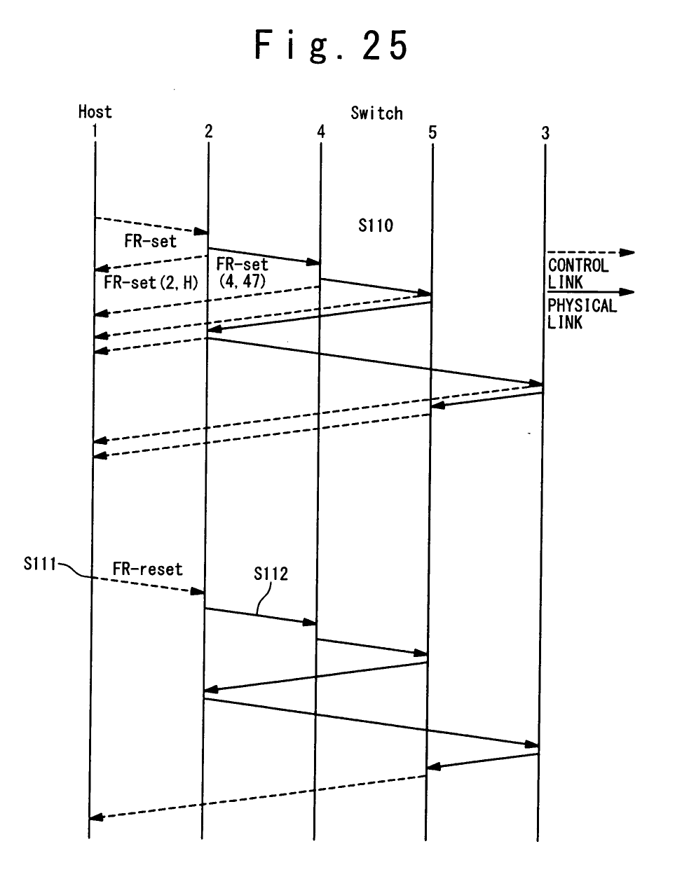

FIG. 25 shows an example of fault recovery processing in the case shown in FIG. 24. The monitoring unit 14 periodically transmits the failure occurrence state notification frame FR-set. If the failure at the physical link 72 between the switch 4 and the switch 5 is resolved, the failure occurrence state notification frame FR-set arrives at the last switch (the N-th switch=switch 5) and returns back to the management host 1. Thereby, the monitoring unit 14 determines that the failure has been resolved. The Steps S111 and S112 are the same as in the case of the first example.

### 5. Effects

The present exemplary embodiment provides a technique of performing centralized management of the communication network NET by using the management host 1. In the communication network management processing, the management host 1 makes the check frame FR travel along a predetermined transfer route PW. Here, each node in the communication network is provided with the forwarding table. The contents of the forwarding table are set up in accordance with the instruction from the management host 1 such that the check frame FR is forwarded along the predetermined transfer route PW. Therefore, each node just needs to refer to the forwarding table to forward the received check frame FR to a designated forwarding destination. Thus, the traveling of the check frame FR along the predetermined transfer route PW is achieved. The management host 1 can detect whether or not a failure is occurring on the transfer route PW based on whether or not it receives the check frame FR within a predetermined period of time.

According to the present exemplary embodiment, there is no need to incorporate the health-check table including information of the transfer route, the check list and the like (see Patent Literature 2, Patent Literature 3) into the check frame FR. Therefore, each node needs not to search for the related entry in the health-check table. In particular, even in a case of a large number of nodes, there is no need to search for the related entry from a large number of entries, and thus a processing time in each node is prevented from increasing. Moreover, each node needs not to refer to the next entry following the related entry in order to forward the check frame FR to the subsequent node. As a result, burden placed on each node is reduced.

Moreover, according to the present exemplary embodiment, it is possible to identify the location of failure on the transfer route PW by simple processing. In the failure location identification processing, each node on the transfer route PW just needs to forward the received check frame FR to both of the transfer route PW and the management host 1. The complicated processing such as required in Patent Literature 2 or Patent Literature 3 is not necessary for identifying the location of failure. For example, such processing as described in Patent Literature 3 that each node investigates whether or not it can communicate with the next node is not necessary. Consequently, burden placed on each node is greatly reduced, and a time required for identifying the location of failure is reduced. Particularly, in a case where the node in the communication network is a switch with a simple configuration, the complicated processing such as required in Patent Literature 2 or Patent Literature 3 is substantially impossible. The present exemplary embodiment can be applied to the case where the node in the communication network is a switch.

Furthermore, according to the present exemplary embodiment, there is no need to issue a “table change instruction” from the management host 1 to all the nodes in order to change the forwarding table of each node after the failure occurrence is detected. According to the present exemplary embodiment, just one failure occurrence state notification frame FR-set that instructs to update the forwarding table needs to be transmitted from the management host 1 to the first node of the transfer route PW. After that, the one failure occurrence state notification frame FR-set is transferred in turn along the transfer route PW up to ahead of the location of failure, and thereby the forwarding tables of necessary nodes are updated in turn. Since there is no need to issue a “table change instruction” from the management host 1 to all the nodes, processing load on the management host 1 can be reduced.

Moreover, in the case where the transfer route PW of the check frame FR is a traversable route, health-checking of a large number of physical links is possible by only transmitting one check frame FR. It is therefore possible to reduce the number of check frames FR that the management host 1 needs to transmit and receive. As a result, burden placed on the management host 1 is reduced, which is preferable. Furthermore, since the burden placed on the management host 1 is reduced, it is possible to increase a transmission frequency of the check frame FR. As a result, it is possible to quickly detect failure occurrence on the transfer route PW.

Moreover, according to the present exemplary embodiment, a ring-shaped network structure is not assumed for achieving the traveling of the check frame FR. The present exemplary embodiment can be applied to a case where the physical topology of the communication network NET is not a ring shape. There is no constraint on the physical topology of the communication network NET.

While the exemplary embodiments of the present invention have been described above with reference to the attached drawings, the present invention is not limited to these exemplary embodiments and can be modified as appropriate by those skilled in the art without departing from the spirit and scope of the present invention.

This application is based upon and claims the benefit of priority from Japanese patent application No. 2009-137524, filed on Jun. 8, 2009, the disclosure of which is incorporated herein in its entirely by reference.

1. A communication network management system comprising:
a communication network including a plurality of nodes and a plurality of links connecting between said plurality of nodes; and
a management computer configured to manage said communication network,
wherein each of said plurality of nodes comprises a forwarding table indicating a correspondence relationship between an input source and a forwarding destination of a frame,
wherein said management computer comprises:
a storage unit in which a route information indicating a transfer route of frames in said communication network is stored; and
a monitoring unit configured to refer to said route information to transmit a frame to said transfer route and to perform identification processing that identifies a location of a failure on said transfer route,
wherein first to N-th nodes (N is an integer equal to or more than 2) line up in order along said transfer route,
the i-th node (i=1 to N−1) forwards a received frame to the (i+1)-th node by referring to said forwarding table, and
the N-th node forwards a received frame to said management computer by referring to said forwarding table,
wherein in said identification processing,
said monitoring unit transmits a state notification frame to said first node,
the i-th node, when receiving said state notification frame, updates said forwarding table by adding said management computer to said forwarding destination and forwards said received state notification frame to the (i+1)-th node through a physical link,
the i-th node, when receiving a check frame, forwards said received check frame to the (i+1)-th node and said management computer by referring to said forwarding table after the update, and
said monitoring unit identifies the location of the failure based on reception state of said check frame from said transfer route.

2. The communication network management system according to claim 1,
wherein said monitoring unit transmits said check frame to said first node, after said forwarding table is updated.

3. The communication network management system according to claim 1,
wherein the i-th node receives said state notification frame as said check frame,
wherein the i-th node, when receiving said state notification frame, updates said forwarding table by adding said management computer to said forwarding destination and forwards said state notification frame as said check frame to the (i+1)-th node and said management computer by referring to said forwarding table after the update.

4. The communication network management system according to claim 1,
wherein in said identification processing, if said monitoring unit receives said check frame from a k-th node (k=1 to N−1) and fails to receive said check frame from a (k+1)-th node, said monitoring unit determines that said failure is occurring between said k-th node and said (k+1)-th node.

5. The communication network management system according to claim 1,
wherein in said identification processing, the i-th node writes an ID number of the i-th node and a port number of the input port to which said check frame is input, in said check frame to be forwarded to said management computer.

6. A management computer that manages a communication network including a plurality of nodes and a plurality of links connecting between said plurality of nodes,
said management computer comprising:
a storage unit in which a route information indicating a transfer route of frames in said communication network is stored; and
a monitoring unit configured to refer to said route information to transmit a frame to said transfer route and to perform identification processing that identifies a location of a failure on said transfer route,
wherein each of said plurality of nodes comprises a forwarding table indicating a correspondence relationship between an input source and a forwarding destination of a frame,
wherein first to N-th nodes (N is an integer equal to or more than 2) line up in order along said transfer route, the i-th node (i=1 to N−1) forwards a received frame to the (i+1)-th node by referring to said forwarding table, and
the N-th node forwards a received frame to said management computer by referring to said forwarding table,
wherein in said identification processing,
said monitoring unit transmits a state notification frame to said first node,
the i-th node, when receiving said state notification frame, updates said forwarding table by adding said management computer to said forwarding destination and forwards said received state notification frame to the (i+1)-th node through a physical link,
the i-th node, when receiving a check frame, forwards said received check frame to the (i+1)-th node and said management computer by referring to said forwarding table after the update, and
said monitoring unit identifies the location of the failure based on reception state of said check frame from said transfer route.

7. A communication network management method that manages a communication network by using a management computer,
wherein said communication network includes a plurality of nodes and a plurality of links connecting between said plurality of nodes,
wherein each of said plurality of nodes comprises a forwarding table indicating a correspondence relationship between an input source and a forwarding destination of a frame,
wherein said communication network management method comprises:
transmitting a frame from said management computer to a transfer route of frames in said communication network,
wherein first to N-th nodes (N is an integer equal to or more than 2) line up in order along said transfer route,
the i-th node (i=1 to N−1) forwards a received frame to the (i+1)-th node by referring to said forwarding table, and
the N-th node forwards a received frame to said management computer by referring to said forwarding table; and
identifying a location of a failure on said transfer route,
wherein said identifying comprises:
transmitting a state notification frame from said management computer to said first node;
updating, in the i-th node that receives said state notification frame, said forwarding table by adding said management computer to said forwarding destination;
forwarding said state notification frame from the i-th node to the (i+1)-th node through a physical link;
forwarding a check frame from the i-th node receiving said check frame to the (i+1)-th node and said management computer in accordance with said forwarding table after the update; and
identifying, by said management computer, the location of the failure based on reception state of said check frame from said transfer route.
